(19) United States
(12) Patent Application Publication
(10) Pub. No.: US 2026/0064328 A1
(43) Pub. Date: Mar. 5, 2026

(54) STORAGE MEDIUM, INFORMATION PROCESSING APPARATUS, AND METHOD FOR CONTROLLING INFORMATION PROCESSING APPARATUS

(71) Applicant: CANON KABUSHIKI KAISHA, Tokyo (JP)

(72) Inventor: KEISUKE NAGAMINE, Kanagawa (JP)

(21) Appl. No.: 19/304,992

(22) Filed: Aug. 20, 2025

(30) Foreign Application Priority Data
Aug. 28, 2024 (JP) 2024-146818

(51) Int. Cl. G06F 3/12; G06K 15/00; G06K 15/02

(52) U.S. Cl. CPC G06F 3/1208; G06F 3/1256; G06K 15/1843; G06K 15/4065

(57) ABSTRACT

Provided is a non-transitory computer-readable storage medium storing a program of an application for print settings for causing an information processing apparatus that communicates with a printing apparatus to execute a method, the method comprising: obtaining sheet size information from the printing apparatus, the sheet size information indicating a sheet size of a printing medium usable in the printing apparatus; obtaining image size information based on the obtaining of the sheet size information in the obtaining sheet size information, the image size information indicating a size of an image which is being edited on the application and is to be printed by the printing apparatus; and performing control to display a setting screen based on the sheet size information and the image size information, the setting screen being where a setting for fitting the image to a sheet width of the printing medium is configurable.

### BACKGROUND

### Field of the Technology

The present disclosure relates to a storage medium, an information processing apparatus, and a method for controlling the information processing apparatus.

### Description of the Related Art

A printer driver has a function to obtain sheet information including a feed method, a sheet type, a printing medium size, and the like from the main body of a printer. Meanwhile, an application for creating posters has a function to apply, to the application, sheet information obtained using the sheet information obtainment function of the printer driver.

Literature 1 (Japanese Patent Laid-Open No. 2009-116735) discloses a technique for displaying a preview of a plurality of pages based on sheet information obtained from a printer and print settings configured on an application. In this way, a user can check a print preview generated based on the sheet information obtained from the printer using the sheet information obtainment function of the printer driver and the print settings configured on the application.

With the method in Literature 1, a printed outcome may have a blank area in a case where the image size and the printing medium size do not match. To eliminate the blank area, the user themselves needs to configure a scale-up or scale-down setting. Thus, a user who wishes to avoid wasting printing media needs to go through the trouble of deciding whether it is necessary to scale up or down based on the image size and the printing medium size and manually configuring the setting before every poster creation.

### SUMMARY

A non-transitory computer-readable storage medium storing a program of an application for print settings for causing an information processing apparatus that communicates with a printing apparatus to execute a method, the method comprising: obtaining sheet size information from the printing apparatus, the sheet size information indicating a sheet size of a printing medium usable in the printing apparatus; obtaining image size information based on the obtainment of the sheet size information in the obtaining image size information, the image size information indicating a size of an image which is being edited on the application and is to be printed by the printing apparatus; and performing control to display a setting screen based on the sheet size information and the image size information, the setting screen being where a setting for fitting the image to a sheet width of the printing medium is configurable.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing an example hardware configuration of an information processing apparatus;

FIG. 2 is a block diagram showing an example hardware configuration of a printing apparatus;

FIG. 3 is a diagram showing an example user interface of a print application;

FIG. 4 shows diagrams of example printed outcomes of poster data printed as an image without being scaled up or down to fit the sheet width;

FIG. 5A is a diagrams showing an example user interface of the print application;

FIG. 5B is a diagrams showing an example user interface of the print application;

FIG. 5C is a diagram showing an example printed outcome of the poster data; and

FIG. 6 is a flowchart showing example information processing executed by the information processing apparatus as a function of the print application.

### DESCRIPTION OF THE EMBODIMENTS

Preferred embodiments of the present disclosure are described in detail below with reference to the drawings attached hereto. Note that the embodiments below are not provided to limit the matters of the present disclosure and that not all the combinations of features described in the embodiments below are necessarily essential as solutions provided by the present disclosure. Note that the same configurations are described using the same reference numeral.

### First Embodiment

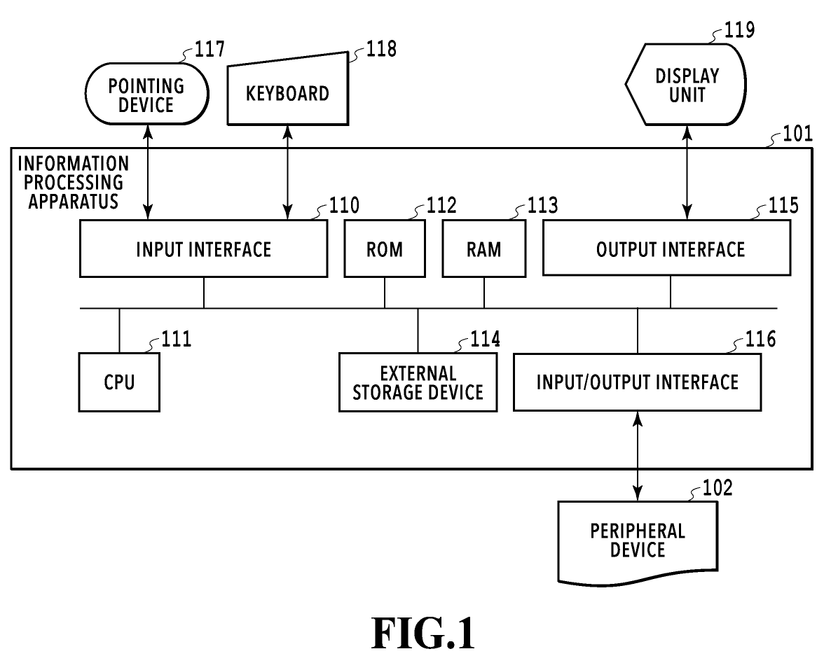

FIG. 1 is a block diagram showing an example hardware configuration of an information processing apparatus 101. With reference to FIG. 1, the configuration of the information processing apparatus of the present embodiment is described.

### Information Processing Apparatus

The information processing apparatus 101 has an input interface 110, a CPU 111, a ROM 112, a RAM 113, an external storage device 114, an output interface 115, and an input/output interface 116. They are connected to one another via a system bus. Input devices such as a keyboard 118 and a pointing device 117 are connected to the input interface 110. A display device such as a display unit 119 is connected to the output interface 115. A peripheral device 102 is connected to the input/output interface 116. The information processing apparatus 101 can transmit and receive various kinds of data via the input/output interface 116.

The CPU 111, which is a system control unit, performs execution of programs, activation of hardware components, and the like and performs overall control of the information processing apparatus 101.

The ROM 112 stores fixed data such as control programs executed by the CPU 111, data tables, an embedded operating system (OS), and programs. In the present embodiment, as managed by the embedded OS stored in the ROM 112, for example, scheduling, task switching, interruption handling, and the like are implemented by the control programs stored in the ROM.

The RAM 113 is formed of static random-access memory (SRAM), dynamic random-access memory (DRAM), or the like requiring a backup power supply. Note that the RAM 113 may hold data using a primary battery for data backup (not shown). In this case, the RAM 113 can retain important data such as program control variables and the like and not lose them. Also, the RAM 113 is also provided with a memory area for storing configuration information on the information processing apparatus 101, management data for the information processing apparatus 101, and the like. Also, the RAM 113 is the main memory for the CPU 111 and is used as workspace memory.

The external storage device 114 stores, e.g., various applications and content data handled by the applications.

The display unit 119 has a light-emitting diode (LED) display, a liquid crystal display (LCD), or the like and performs presentation of data and notification of the status of the information processing apparatus 101. The CPU 111 performs display control to display predetermined screens, predetermined notifications, various messages, and the like on the display unit 119.

Note that by having software keys such as numeric keys, a mode setting key, an enter key, a cancel key, and a power key on the display unit 119, the information processing apparatus 101 can receive user inputs via the display unit 119. In this case, an input/output interface is used as the output interface 115 to enable the reception of user inputs.

### Printing Apparatus

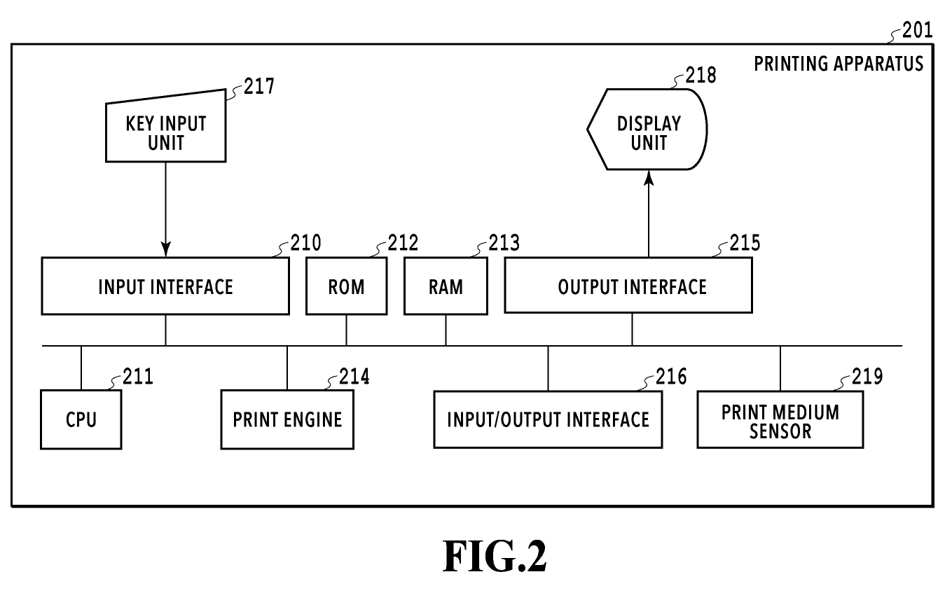

FIG. 2 is a block diagram showing an example hardware configuration of a printing apparatus 201 of the present embodiment. The printing apparatus 201 has an input interface 210, a CPU 211, a ROM 212, a RAM 213, a print engine 214, an output interface 215, an input/output interface 216, and a printing medium sensor 219. They are connected to one another via a system bus.

The printing apparatus 201 has a key input unit 217. The key input unit 217 is connected to the input interface 210. The key input unit 217 is formed of hardware keys such as numeric keys, a mode setting key, an enter key, and a cancel key and receives operations from a user.

The printing apparatus 201 has a display unit 218. The display unit 218 is connected to the output interface 215 and formed of a liquid crystal display (LCD) or the like. For example, the display unit 218 displays print data received through the input/output interface 216 or the like and presents the status of the printing apparatus 201.

The CPU 211 is a system control unit and performs overall control of the printing apparatus 201. The ROM 212 stores fixed data such as control programs executed by the CPU 211 and data tables. The RAM 213 is used as workspace memory by the CPU 211 and is also used as a buffer for temporarily storing a print job. The print engine 214 forms an image on a printing medium such as paper using a printing material such as ink based on data stored in the RAM 213 and a print job received from the information processing apparatus 101 and outputs a printed outcome. The connection between the input/output interface 116 of the information processing apparatus 101 and the input/output interface 216 of the printing apparatus 201 enables the information processing apparatus 101 and the printing apparatus 201 to communicate with each other. Thus, sheet information including, e.g., information indicative of the size of a printing medium supplied to the printing apparatus 201 and detected by the printing medium sensor 219 and information indicative of the type of the printing medium can be communicated between the information processing apparatus 101 and the printing apparatus 201. Note that they may be connected to each other through, but not limited to, a network connection.

### Poster Creation Application

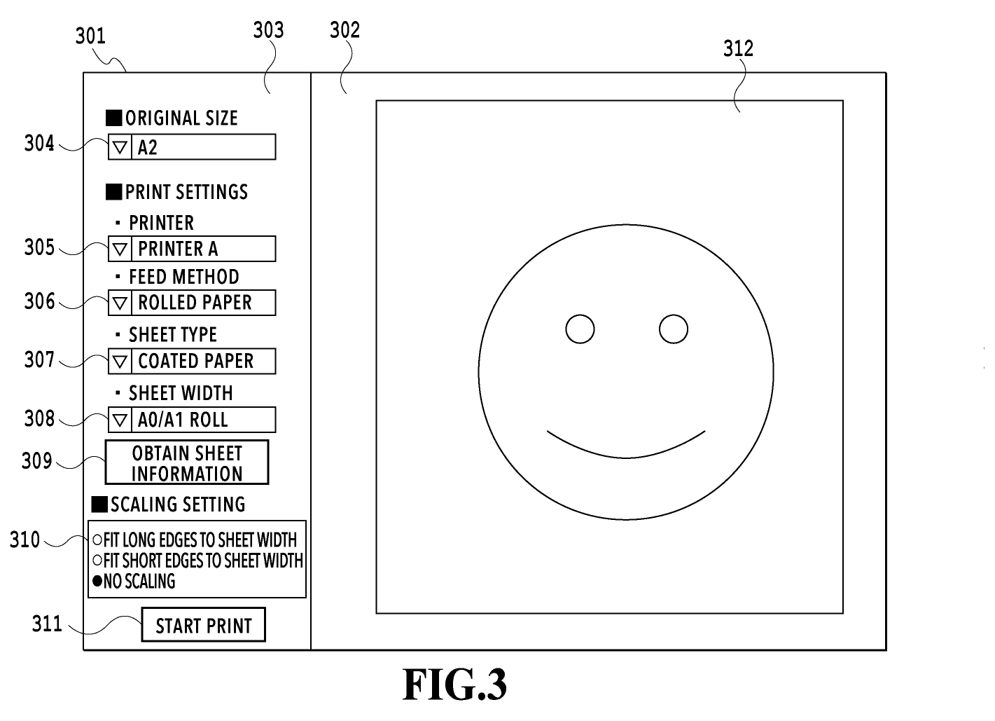

FIG. 3 is a diagram showing an example of a poster edit screen (a UI screen) displayed on the display unit 119 by the CPU 111 of the information processing apparatus 101 by executing a program corresponding to a poster creation application stored in, for example, the external storage device 114. With reference to FIG. 3, the configuration of a poster edit screen 301 of the present embodiment is described.

The poster edit screen 301 is a screen used by a user to edit poster data 312 to be described later and configure print settings on the poster data 312. The poster edit screen 301 has a poster preview field 302 and a settings field 303. The settings field 303 is provided with an original size setting unit 304, a printer setting unit 305, a feed method setting unit 306, a sheet type setting unit 307, a sheet width setting unit 308, an Obtain Sheet information button 309, a scaling setting unit 310, and a Print button 311.

A preview of the poster data 312 is displayed in the poster preview field 302. The user can change a poster layout while checking a preview of the poster data 312 displayed in the poster preview field 302.

The original size setting unit 304 is an operator for receiving selection of the image size of the poster data 312. The image size of the poster data 312 is changed according to the value selected in the original size setting unit 304 and indicating the image size of the poster data 312. Then, the poster data 312 after the change is displayed in the poster preview field 302.

FIG. 3 shows a state where "A2" is set in the original size setting unit 304. Once the Print button 311 to be described is pressed in this state, the poster data 312 is printed as an image in A2 size.

The printer setting unit 305 is an operator for receiving selection of a printer used to output an image. FIG. 3 shows a state where "Printer A" is set in the printer setting unit 305. Once the Print button 311 to be described later is pressed in this state, a print job is transmitted to Printer A, and Printer A executes a printing process.

The feed method setting unit 306, the sheet type setting unit 307, and the sheet width setting unit 308 are operators for receiving settings on the printing medium used for printing. The Obtain Sheet information button 309 is an operator for receiving an instruction to obtain sheet information from the printer set in the printer setting unit 305. Sheet information in the present embodiment includes information such as the printing medium feed method, the type of the printing medium, and the size of the printing medium.

Once the Obtain Sheet information button 309 is pressed by a user, the poster creation application obtains, from the printer set in the printer setting unit 305, settings information on print media usable in the printer. The settings information on print media obtained from the printer includes sheet information.

As a result of obtaining the sheet information, setting values of print media usable in the printer set in the printer setting unit 305 can be displayed in a list form in each of the feed method setting unit 306, the sheet type setting unit 307, and the sheet width setting unit 308.

Note that the feed method setting unit 306, the sheet type setting unit 307, and the sheet width setting unit 308 may be configured so that setting values therein may be manually selectable by a user. For example, sheet information associated with a printer settable in the printer setting unit 305 may be stored in the external storage device 114 as an internal program of the poster creation application or an external file. In this case, based on the sheet information stored, setting values corresponding to the sheet information may be displayed in the feed method setting unit 306, the sheet type setting unit 307, and the sheet width setting unit 308 in a selectable manner.

Thus, without pressing the Obtain Sheet information button 309, a user can manually select and change setting values in the feed method setting unit 306, the sheet type setting unit 307, and the sheet width setting unit 308.

The present embodiment provides a description, taking an example where rolled paper is set in the feed method setting unit 306 as a printing medium to use for image printing.

The scaling setting unit 310 is provided with a selection box where one of "Fit Long Edges to Sheet width," "Fit Short Edges to Sheet width," and "No Scaling" can be selected. In a case where "Fit Long Edges to Sheet width" is selected and the poster data 312 is in portrait orientation, the vertical edges of the poster data 312 are scaled up or down to fit the sheet width. In this event, the poster data 312 is rotated by 90 degrees and scaled up or down. Also, in a case where the poster data 312 is in landscape orientation, the horizontal edges of the poster data 312 are scaled up or down to fit the sheet width.

In a case where "Fit Short Edges to Sheet width" is selected and the poster data 312 is in portrait orientation, the horizontal edges of the poster data 312 are scaled up or down to fit the sheet width. Also, in a case where the poster data 312 is in landscape orientation, the vertical edges of the poster data 312 are scaled up or down to fit the sheet width. In this event, the poster data 312 is rotated by 90 degrees and scaled up or down.

In a case where "No Scaling" is selected, the poster data 312 is printed as an image in the same size as the size set in the original size setting unit 304. Note that an error occurs in a case where an image cannot be printed in the size set in the original size setting unit 304 using rolled paper with the sheet width selected in the sheet width setting unit 308. For example, an image cannot be printed in a case where the length of either edges of an image indicated by the image size set in the original size setting unit 304 is longer than the sheet width selected in the sheet width setting unit 308.

The Print button 311 is an operator for receiving an instruction to execute a printing process. Once the Print button 311 is pressed by the user, the poster creation application passes image data obtained by rendering the poster data 312 to the driver for the printer selected in the printer setting unit 305. Then, the printer selected in the printer setting unit 305 executes printing.

The present embodiment describes an example where the poster edit screen 301 is displayed by the poster creation application, but the present disclosure is not limited to this. For example, the poster edit screen 301 may be provided by a server providing a cloud print service. In this case, the user uploads the poster data 312 to the server and configures print settings on a poster edit screen provided by the server. In order to access such a server, the information processing apparatus 101 may be equipped with a typical web browsing function. In this case, the information processing apparatus 101 can display the poster edit screen 301 through a web browser.

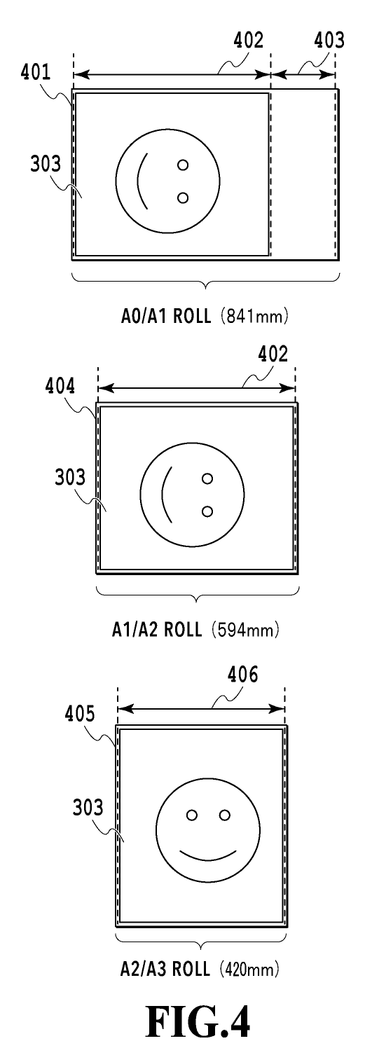

FIG. 4 shows diagrams of example printed outcomes of the poster data 312 printed as an image without being scaled up or down to fit the sheet width set in the sheet width setting unit 308.

The top diagram in FIG. 4 shows a printed outcome of the poster data 312 printed as an image in A2 size without being scaled up or down, using rolled paper 401 in A0/A1 (841.0 mm wide) size. In this case, the rolled paper has a 247-mm blank area 403 because the rolled paper is 841 mm in width and the vertical width 402 of the image represented by the poster data 312 is 594 mm.

The middle diagram of FIG. 4 shows a printed outcome of the poster data 312 printed as an image in A2 size without being scaled up or down, using rolled paper 404 in A1/A2 (594 mm wide) size. In this case, the rolled paper has no blank area because the rolled paper is 594 mm in width and the vertical width 402 of the image represented by the poster data 312 is 594 mm.

The bottom diagram of FIG. 4 shows a printed outcome of the poster data 312 printed as an image in A2 size without being scaled up or down, using rolled paper 405 in A2/A3 (420 mm wide) size. In this case, the rolled paper has no blank area similarly with the top diagram in FIG. 4 because the rolled paper is 420 mm in width and the horizontal width 406 of the image represented by the poster data 312 is 420 mm.

Next, a description is given of information processing performed by the information processing apparatus 101 in executing the poster creation application of the present embodiment. The present embodiment describes an example where the information processing apparatus 101 obtains sheet information including a feed method, a sheet size, a sheet type, and the like from the printing apparatus 201 and displays a scaling setting dialog based on the sheet information obtained.

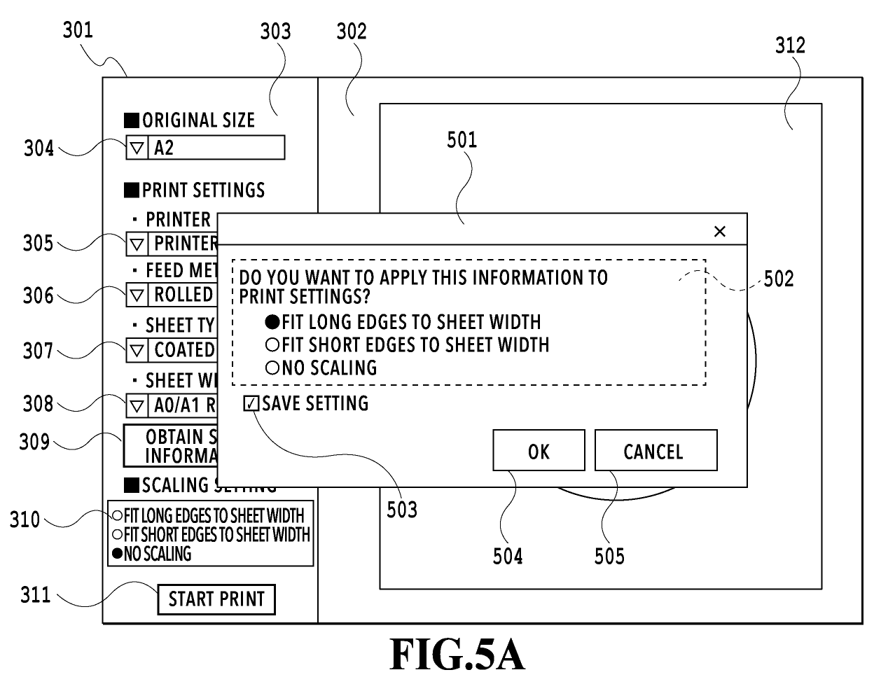

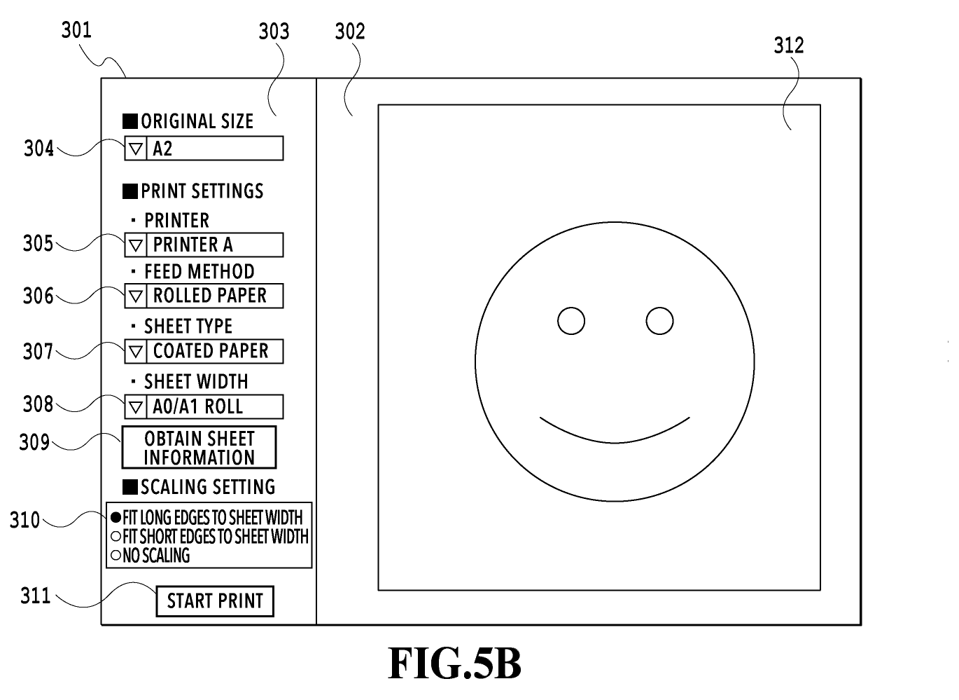

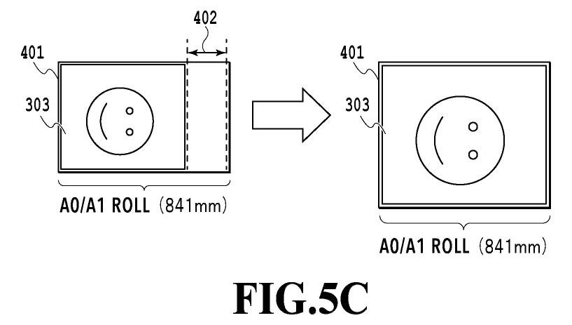

FIG. 5A is a diagram showing a state where a scaling setting dialog 501 is displayed on the poster edit screen 301 while a user is editing or configuring print settings of the poster data 312. The scaling setting dialog 501 is a setting screen where a user can configure a setting related to scaling up or scaling down of the poster data 312.

For example, the scaling setting dialog 501 is displayed in a case where the poster data 312 needs to be scaled up or down, provided that sheet information is obtained from the printer and the image size set in the original size setting unit 304 is obtained. Details of when the scaling setting dialog 501 is displayed will be described later.

The scaling setting dialog 501 is provided with a Save Setting checkbox 503 in addition to a selection box similar to that in the scaling setting unit 310. The Save Setting checkbox 503 functions as a receiving unit capable of receiving an instruction to save a setting 502.

The scaling setting dialog 501 is also provided with an OK button 504 and a Cancel button 505. Once the OK button 504 is pressed by a user, the setting 502 on the scaling setting dialog 501 is applied to the scaling setting unit 310. Once the Cancel button 505 is pressed by a user, the setting 502 on the scaling setting dialog 501 is not applied to the scaling setting unit 310, and the scaling setting dialog 501 is closed.

FIG. 5B is the poster edit screen 301 to which the setting 502 on the scaling setting dialog 501 shown in FIG. 5A has been applied. Because "Fit Long Edges to Sheet width" is selected on the scaling setting dialog 501 in FIG. 5A, this setting is applied to the scaling setting unit 310 as well.

FIG. 5C is a diagram showing an example printed outcome of the poster data 312 printed as an image under the settings shown in FIG. 5B. As described earlier, in a case where the poster data 312 is printed as an image in A2 size without being scaled up or down using the rolled paper 401 in A0/A1 size, the rolled paper has a 247-mm blank area 403. By contrast, in a case where the poster data 312 is printed under the settings shown in FIG. 5B, the long edges of the image of the poster data 312 are scaled up to the sheet width, creating no blank on the rolled paper.

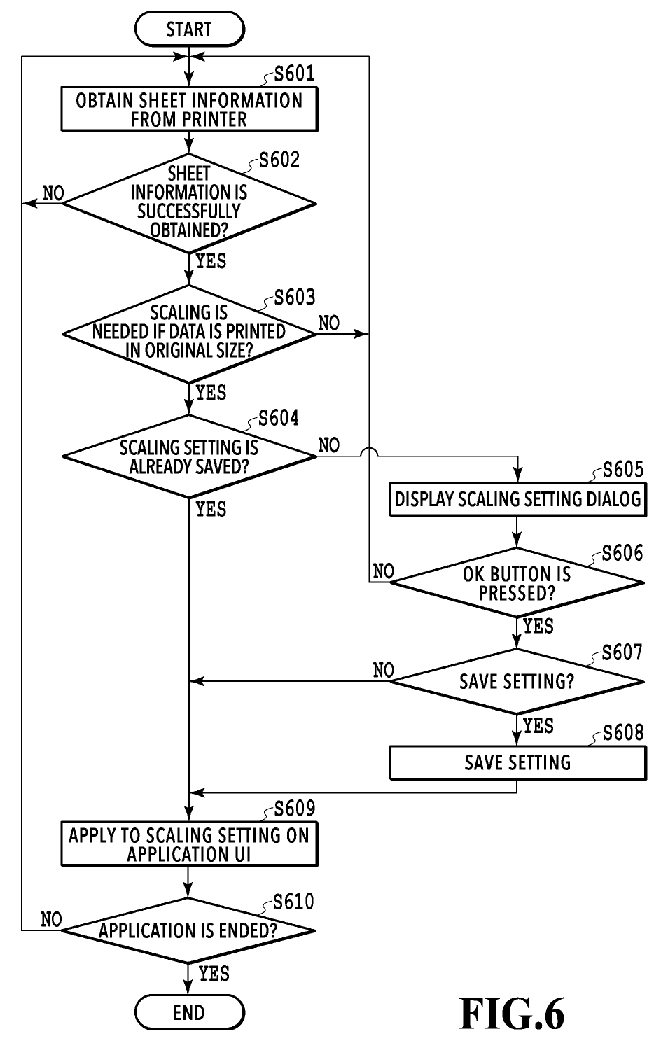

FIG. 6 is a flowchart of information processing executed by the CPU 111 of the information processing apparatus 101 as a function of the poster creation application. With reference to FIG. 6, a description is given of processing where the poster creation application scales up or down an image to be printed to fit it to the printing medium and displays the result on the poster edit screen 301.

The processing shown in the flowchart in FIG. 6 is implemented by the CPU 111 of the information processing apparatus 101 by loading the program of the poster creation application stored in the external storage device 114 or the like into the RAM 113 and executing the loaded program. Note that some or all of the functions in the steps in FIG. 6 may be implemented by hardware such as an ASIC or an electronic circuit. The letter "S" in the description of each process means that it is a step in the flowchart (this applies to the other flowcharts herein as well). The processing shown in the flowchart in FIG. 6 starts once the poster creation application is activated and the poster edit screen 301 is displayed on the display unit 119.

In S601, the CPU 111 obtains sheet information from the printer set in the printer setting unit 305 provided on the poster edit screen 301. It is assumed here that the CPU 111 obtains sheet information from the printer set in the printer setting unit 305 upon pressing of the Obtain Sheet information button 309. Specifically, the CPU 111 obtains information from the printer, such as feed method information, sheet size information, and sheet type information.

For example, upon detection of pressing of the Obtain Sheet information button 309, the CPU 111 proceeds to S601 and obtains sheet information from the printer set in the printer setting unit 305.

Although the CPU 111 obtains sheet information upon a user's operation of pressing the Obtain Sheet information button 309 in the present embodiment as an example, the sheet information obtainment method is not limited to this. For example, once the poster edit screen 301 is displayed, the CPU 111 may obtain sheet information from the printer set by default or the printer set previously. Also, the CPU 111 may obtain sheet information once the printer for print output is changed in the printer setting unit 305.

In S602, the CPU 111 determines whether sheet information has been successfully obtained. If it is determined that sheet information has been successfully obtained (YES), the CPU 111 proceeds to S603, and if it is determined that sheet information has not been successfully obtained (NO), the CPU 111 proceeds back to S601. If sheet information has been successfully obtained, the CPU 111 applies setting values based on the obtained sheet information to the feed method setting unit 306, the sheet type setting unit 307, and the sheet width setting unit 308, respectively.

In S603, the CPU 111 determines whether the poster data 312 needs to be scaled up or down in a case where the poster data 312 is printed as an image in the size set in the original size setting unit 304. This determination is to determine whether the rolled paper will have a blank area or the poster data 312 can be printed in the image size if the poster data 312 is printed as an image in the size set in the original size setting unit 304. The CPU 111 makes this determination by obtaining image size information indicative of the size of the poster data 312 from the original size setting unit 304.

It is assumed here that the sheet information is obtained from Printer A set in the printer setting unit 305, and setting values for the feed method setting unit 306, the sheet type setting unit 307, and the sheet width setting unit 308 are successfully obtained. Also, the following scenario is used: the poster data 312 is created in A2 size set in the original size setting unit 304, and "No Scaling" is selected in the scaling setting unit 310.

Also, the value set in the original size setting unit 304 is "A2," and the value set in the sheet width setting unit 308 is "A0/A1 roll." In this case, the rolled paper will have a blank area irrespective of whether the image of the poster data 312 is printed in portrait orientation as is or is rotated by 90 degrees and printed in landscape orientation.

If it is determined in S603 that the poster data 312 needs to be scaled up or down in a case where the poster data 312 is printed as an image in the size set in the original size setting unit 304 (YES), the CPU 111 proceeds to S604. The CPU 111 determines "YES" in S603 in a case where, for example, it is determined that a blank area will be generated on the rolled paper because the long edges of the image of the poster data 312 are shorter than the width of the rolled paper.

If it is determined in S603 that the poster data 312 does not need to be scaled up or down in a case where the poster data 312 is printed as an image in the size set in the original size setting unit 304 (NO), the CPU 111 does not execute processing in the subsequent steps and proceeds back to S601. The CPU 111 determines "NO" in S603 in a case where, for example, it is determined that a blank area will not be generated or the poster data 312 cannot be printed in the image size. Note that if it is determined in S603 that the poster data 312 cannot be printed in the image size, the CPU 111 may display an error message on the poster edit screen 301 to notify that the data cannot be printed.

In S604, the CPU 111 determines whether the setting 502 has been saved in the external storage device 114 or the like in the past by a user's operation of checking the Save Setting checkbox 503 provided on the scaling setting dialog 501 in FIG. 5A.

If it is determined in S604 that the setting 502 has been saved in the external storage device 114 in the past (YES), the CPU 111 proceeds to S609. If it is determined in S604 that the setting 502 has not been saved in the external storage device 114 in the past (NO), the CPU 111 proceeds to S605. It is assumed here that a setting has not been saved in the past.

In S605, the CPU 111 displays the scaling setting dialog 501 on the display unit 119 and proceeds to S606. In S606, the CPU 111 determines whether the OK button 504 provided on the scaling setting dialog 501 thus displayed has been pressed. If it is determined that the OK button 504 has been pressed (YES), the CPU 111 proceeds to S607. If it is determined in S606 that the Cancel button 505 provided on the scaling setting dialog 501 has been pressed (NO), the CPU 111 does not perform processing in the subsequent steps and proceeds back to S601.

In S607, the CPU 111 determines whether the Save Setting checkbox 503 on the scaling setting dialog 501 is checked. If it is determined that the Save Setting checkbox 503 is checked (YES), the CPU 111 proceeds to S608. In S608, the CPU 111 saves the setting 502 on the scaling setting dialog 501 in the external storage device 114 or the like and proceeds to S609.

If it is determined in S607 that the Save Setting checkbox 503 is not checked (NO), the CPU 111 does not save the setting on the scaling setting dialog 501 and proceeds to S609. In S607, the setting on the scaling setting dialog 501 may be saved as one piece of setting information for the poster creation application. Also, in S607, the setting on the scaling setting dialog 501 may be saved for the printer set in the printer setting unit 305 or for the combination of the original size setting unit 304 and the sheet width setting unit 308.

In S609, the CPU 111 applies the setting on the scaling setting dialog 501 to the scaling setting unit 310 and proceeds to S610.

Note that if it is determined "YES" in S604, in S609 the CPU 111 displays, in the scaling setting unit 310, the setting saved in association with the print settings configured in the setting units provided in the settings field 303, such as the original size setting unit 304. In this case, the CPU 111 does not display the scaling setting dialog 501. In this way, in a case where a setting configured in the past is saved, the image scaling setting is automatically applied to the poster edit screen 301, which saves the user some trouble.

In S610, the CPU 111 determines whether the poster creation application has ended. If it is determined that the poster creation application has ended (YES), the CPU 111 ends the flowchart. If it is determined that the poster creation application has not ended (NO), the CPU 111 proceeds back to S601.

According to the present embodiment, the information processing apparatus obtains sheet information from the printing apparatus and displays a scaling setting dialog in a case where image data needs to be scaled up or down, which makes it possible to print the image data without generating a blank area on rolled paper. Also, saving a setting configured on the scaling setting dialog can save a user the trouble of configuring a scaling setting. Thus, according to the present disclosure, an image can be printed with efficient use of a printing medium and with less operational burden on the user.

### Other Embodiments

In the first embodiment described above, a user can manually select and change setting values in the feed method setting unit 306, the sheet type setting unit 307, and the sheet width setting unit 308. In a case where the Obtain Sheet information button 309 is pressed after the user manually selects these setting values, the CPU 111 may obtain sheet information from the printer and determine whether the setting values manually selected by the user match with the setting values specified in the sheet information.

For example, if it is determined in S602 that sheet information has been successfully obtained (YES), the CPU 111 further determines whether the setting values manually selected by the user match with the setting values specified in the sheet information. If it is determined that the setting values do not match, the CPU 111 may display, on the poster edit screen 301, an error message notifying that there is a discrepancy between the setting values obtained from the printer and the values manually configured by the user.

In the first embodiment described above, upon pressing of the Print button 311 with "Printer A" being set in the printer setting unit 305, a print job is transmitted to Printer A, and Printer A executes a printing process. The CPU 111 may obtain sheet information from Printer A upon pressing of the Print button 311. In this case, the CPU 111 determines whether the setting values configured in the feed method setting unit 306, the sheet type setting unit 307, and the sheet width setting unit 308 match with the setting values specified in the sheet information obtained. Then, if it is determined that the setting values do not match, the CPU 111 may display, on the poster edit screen 301, an error message notifying that there is a discrepancy between the current setting values of Printer A and the values configured in the setting units.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2024-146818, filed August 28, 2024, which is hereby incorporated by reference herein in its entirety.

What is claimed is:

1. A non-transitory computer-readable storage medium storing a program of an application for print settings for causing an information processing apparatus that communicates with a printing apparatus to execute a method, the method comprising:
obtaining sheet size information from the printing apparatus, the sheet size information indicating a sheet size of a printing medium usable in the printing apparatus;
obtaining image size information based on the obtainment of the sheet size information in the obtaining sheet size information, the image size information indicating a size of an image which is being edited on the application and is to be printed by the printing apparatus; and
performing control to display a setting screen based on the sheet size information and the image size information, the setting screen being where a setting for fitting the image to a sheet width of the printing medium is configurable.

2. The storage medium according to claim 1, wherein in the obtaining sheet size information, the sheet size information is obtained from the printing apparatus based on a user instruction to obtain the sheet size information.

3. The storage medium according to claim 1, wherein the setting screen is a screen displayed in a dialog form.

4. The storage medium according to claim 1, wherein in the performing control, an edit screen is displayed, the edit screen including a preview field of the image being edited and a setting field where a print setting is configurable, and control is performed so that a setting value configured on the setting screen is displayed in the setting field.

5. The storage medium according to claim 1, wherein the setting configurable on the setting screen is a setting to scale down the image to fit the image to the sheet width of the printing medium or a setting to scale up the image to fit the image to the sheet width of the printing medium.

6. The storage medium according to claim 1, wherein in a case where a length of long edges of the image is shorter than the sheet width of the printing medium, control is performed in the performing control to display the setting screen.

7. The storage medium according to claim 4, wherein the setting screen is provided with a reception unit capable of receiving an instruction to store the print setting and the setting value in association with each other, and the method further comprises storing the print setting and the setting value in association with each other in a case where the reception unit is operated by a user.

8. The storage medium according to claim 7, wherein in a case where the print setting configured in the setting field is not stored in the storing, control is performed in the performing control to display the setting screen.

9. The storage medium according to claim 8, wherein in a case where the print setting configured in the setting field is stored in the storing, control is performed in the performing control not to display the setting screen and to display, in the setting field, a setting value associated with the print setting.

10. The storage medium according to claim 1, wherein the print setting includes a setting for a size of the image, a setting for the printing apparatus, a setting for the sheet width of the printing medium, and the setting configurable on the setting screen.

11. An information processing apparatus implementing an application for print settings and communicatively connected to a printing apparatus, the information processing apparatus comprising:
a first obtainment unit configured to obtain sheet size information from the printing apparatus, the sheet size information indicating a sheet size of a printing medium usable in the printing apparatus;
a second obtainment unit configured to obtain image size information based on the obtainment of the sheet size information by the first obtainment unit, the image size information indicating a size of an image which is being edited on the application and is to be printed by the printing apparatus; and
a display control unit configured to perform control to display a setting screen based on the sheet size information and the image size information, the setting screen being where a setting for fitting the image to a sheet width of the printing medium is configurable.

12. A method for controlling an information processing apparatus implementing an application for print settings and communicatively connected to a printing apparatus, the method comprising:
obtaining sheet size information from the printing apparatus, the sheet size information indicating a sheet size of a printing medium usable in the printing apparatus;
obtaining image size information based on the obtainment of the sheet size information in the obtaining sheet size information, the image size information indicating a size of an image which is being edited on the application and is to be printed by the printing apparatus; and
performing control to display a setting screen based on the sheet size information and the image size information, the setting screen being where a setting for fitting the image to a sheet width of the printing medium is configurable.
